(19) United States
(12) Patent Application Publication
(10) Pub. No.: US 2025/0175546 A1
(43) Pub. Date: May 29, 2025

(54) PALM-BACK FOLDABLE SMARTPHONE

(71) Applicant: Ciyuan Li, Changsha (CN)

(72) Inventor: Ciyuan Li, Changsha (CN)

(21) Appl. No.: 18/519,422

(22) Filed: Nov. 27, 2023

(51) Int. Cl. H04M 1/02; H04M 1/04

(52) U.S. Cl. CPC H04M 1/0214; H04M 1/04

(57) ABSTRACT

A palm-back foldable smartphone comprises a glove and a smartphone, the surface of the glove and the back of the smartphone are provided with fixing parts that can be detachably connected to each other, the smartphone is a foldable screen smartphone; the glove is provided with inductive intermediaries in contact with the back of the hand, and the inductive intermediaries are connected to the signals of the smartphone; the surface of the glove is symmetrically provided with zipper openings on both sides of the fixing part. The invention fixes the glove with the smartphone through Velcro or magnetic materials, and the smartphone adopts a foldable screen smartphone, which is convenient for daily operation and use by users, is easy to carry, has powerful functions, and can be used to monitor heart rate, blood pressure, etc., thereby protecting the user's life and health.

### 1. TECHNICAL FIELD

The invention relates to the technical field of mobile phones, in particular to a palm-back foldable smartphone.

### 2. BACKGROUND ART

The use of mobile phones has become an indispensable information device for modern humans and has been deeply integrated into everyone's life, work and study. Busy work and high-frequency use have made mobile phone users begin to feel that the way they hold their mobile phones is a burden. With the advancement of technology and the increasing demand for high-quality and high-efficiency living environment, there are continuous upgrades and replacements of lightweight and powerful smartphones and personal portable mobile terminals, meeting the needs of people from different levels in work and daily life. Various auxiliary usage methods are used to make the use of mobile phones more convenient. From the evolution of pocket watches to watches, some people followed this process on mobile phones and invented wrist-style watch-style mobile phones. However, it was far-fetched to place the mobile phone on the wrist and there were many inconveniences. The watch-style mobile phones could not change the way most people use it, and cannot achieve the object of widespread application.

Firstly, from an ergonomic standpoint, it is inconvenient for long-term use, especially around the wrist area. You can just glance at the time, but most of the functions on a mobile phone involve browsing and processing information. Rolling up one's sleeves to send a text message or handle a few minutes of news can be quite painful.

Secondly, the size of a watch-style mobile phone and its use on the wrist are not suitable for men wearing suits or those who wear long-sleeved shirts with buttoned cuffs.

In conclusion, handheld mobile phones have brought many problems due to their inconvenience in carrying in the fast-paced lifestyle of today's society. Too small mobile phones are easy to lose and difficult to operate, and the work before use is cumbersome. All of these issues cause inconvenience and stress for users in certain environments, affecting their productivity and daily lives. Wrist-style watch-style mobile phones have their fatal shortcomings: limited volume, restrictions on fixed parts, operation methods and information display problems bring bottlenecks for their popularization and application.

Therefore, a palm-back foldable smartphone has become an urgent problem to be solved.

### 3. Summary of the Invention

The object of the invention is to provide a palm-back foldable smartphone that is convenient to carry, easy to use, and has powerful function.

To realize the above objects, the technical scheme provided by the invention is as follow: a palm-back foldable smartphone comprises a glove and a smartphone, the surface of the glove and the back of the smartphone are provided with fixing parts that can be detachably connected to each other, the smartphone is a foldable screen smartphone; the glove is provided with inductive intermediaries in contact with the back of the hand, and the inductive intermediaries are connected to the signals of the smartphone; the surface of the glove is symmetrically provided with zipper openings on both sides of the fixing part.

As an improvement, the fixing part comprises Velcro and magnets.

As an improvement, the glove is made of elastic nylon material.

As an improvement, the inductive intermediaries comprise a blood pressure sensor and a heart rate sensor.

As an improvement, the smartphone is equipped with a special stylus.

Compared with the prior art, the invention has the following advantages: the invention fixes the glove with the smartphone through Velcro or magnetic materials, and the smartphone adopts a foldable screen smartphone, which is convenient for daily operation and use by users, is easy to carry, has powerful functions, and can be used to monitor heart rate, blood pressure, etc., thereby protecting the user's life and health.

### 4. BRIEF DESCRIPTION OF ACCOMPANY DRAWINGS

FIG. 1 is a usage state diagram 1 of a palm-back foldable smartphone of the invention.

FIG. 2 is a usage state diagram 2 of a palm-back foldable smartphone of the invention.

FIG. 3 is a usage state diagram of the glove.

As shown in the FIGS.: 1 glove, 2 smartphone, 3 fixing part, 4 inductive intermediary, 5 zipper opening.

### 5. SPECIFIC EMBODIMENT OF THE INVENTION

In the description of the invention, it should be understood that the orientation or positional relationship indicated by the terms “upper”, “lower”, “front”, “back”, “left”, “right”, “inner”, “outer”, “vertical”, “circumferential” and so on are based on the orientation or positional relationship shown in the accompanying drawings, only for the convenience of describing the invention and simplifying the description, rather than indicating or implying that the indicated device or element must have a specific orientation, as well as a specific orientation structure and operation, therefore, it should not be construed as a limitation of the invention.

In the invention, it should be noted that the terms of “arrange”, “connected”, “connect”, “fix”, etc., should be generally understood unless there are specific restrictions or stipulations, for example, the “connect” may refer to fixed connection, detachable connection or integral connection; the means of “connect” may be a mechanical connection or an electrical connection; may be directly connected or indirectly connected through an intermediate medium, may be an internal connection between two components. For those skilled in the art, the specific meaning of the above terms in the invention can be understood according to the specific situation.

A palm-back foldable smartphone of the invention will be further described in detail below in combination with the accompanying drawings.

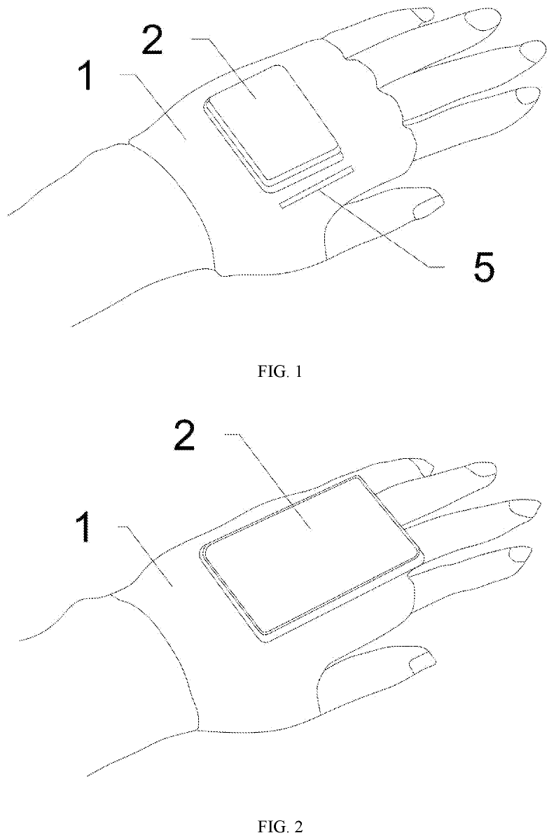

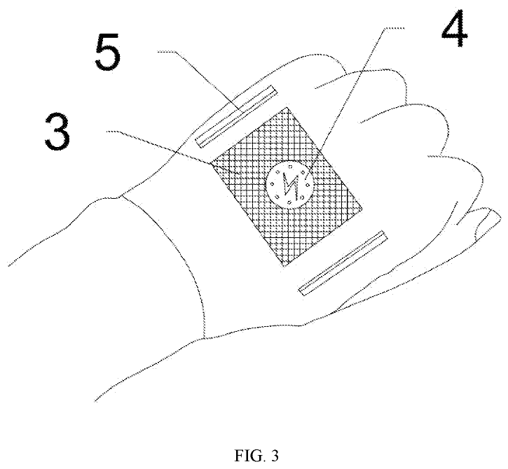

The invention is introduced in detail with reference to FIG. 1-3.

A palm-back foldable smartphone comprises a glove 1 and a smartphone 2, the surface of the glove 1 and the back of the smartphone 2 are provided with fixing parts 3 that can be detachably connected to each other, the smartphone 2 is a foldable screen smartphone; the glove 1 is provided with inductive intermediaries 4 in contact with the back of the hand, and the inductive intermediaries 4 are connected to the signals of the smartphone 2; the surface of the glove 1 is symmetrically provided with zipper openings 5 on both sides of the fixing part 3.

The fixing part 3 comprises Velcro and magnets; the glove 1 is made of elastic nylon material; the inductive intermediaries 4 comprise a blood pressure sensor and a heart rate sensor; the smartphone 2 is equipped with a special stylus.

The specific implementation process of the palm-back foldable smartphone of the invention is as follow:

The foldable screen smartphone 2 is the standard configuration style, and its surface can be equipped with various styles of surface models; it can be applied to various common needs, such as time display, map navigation, music playback, phone calls, payments, watch style transformation, and distinctive surface display, etc.

The foldable screen smartphone 2 and the special glove 1 are tightly integrated into a whole body by Velcro, and can also be attached by using metal magnetic materials.

The glove 1 is required to be made of elastic nylon material, the glove 1 fits tightly with the hand and is comfortable and convenient to take out and put on.

The middle part of the glove 1 is equipped with various sensor-based intermediaries 4, which are used to connect the surface of the human body with the foldable screen smartphone 2, this allows for better measurement of various human body parameters such as blood pressure, heart rate, blood sugar, and so on.

The gloves 1 can be made into various colors and graphics, suitable for adults, men and women, the elderly, and children, so as to achieve beautiful hands, beautiful palms and fitness.

The standard configuration palm-back foldable smartphone 2 can have a core that can be made into a standard housing, and the surface size can be made into different sizes, one device can be paired with multiple gloves 1, and the golve of the smartphone 2 has zipper openings 5 for standard belts.

The foldable screen smartphone 2 can be expanded into a small, standard, smart and high-end smartphone 2, it can be operated with one hand or both hands, and can be used in both portrait and landscape modes. It has basic text functions. You can read text messages without any problem; you can also view pictures and videos, and you can uese the input methods such as “Five Strokes”, Pinyin and handwriting. It can be equipped with a stylus, and the screen can also be added with a screen stretching function.

It can be used with various APPs to control various household appliances, can support navigation, voice commands, music playback, and can be used with dedicated headphones, etc.

It can be customized according to personal needs to create dedicated fitness gloves, artistic gloves, and can also be made into a complete waterproof set of equipment.

The invention can also be worn around the waist through the dedicated zipper openings 5.

The invention and its embodiments are described above, this description is not restrictive, and what is shown in the accompanying drawing is only one of the embodiments of the invention, and the actual structure is not limited to this. All in all, if those skilled in the art receives its enlightenment, without deviating from the object of the invention, and without creatively designing structures and embodiments similar to the technical scheme of the invention shall fall within the protection scope of the invention.

1. A palm-back foldable smartphone comprises a glove (1) and a smartphone (2), the surface of the glove (1) and the back of the smartphone (2) are provided with fixing parts (3) that can be detachably connected to each other, the smartphone (2) is a foldable screen smartphone; the glove (1) is provided with inductive intermediaries (4) in contact with the back of the hand, and the inductive intermediaries (4) are connected to the signals of the smartphone (2); the surface of the glove (1) is symmetrically provided with zipper openings (5) on both sides of the fixing part (3).

2. A palm-back foldable smartphone of claim 1, the fixing part (3) comprises Velcro and magnets.

3. A palm-back foldable smartphone of claim 2, the glove (1) is made of elastic nylon material.

4. A palm-back foldable smartphone of claim 3, the inductive intermediaries (4) comprise a blood pressure sensor and a heart rate sensor.

5. A palm-back foldable smartphone of claim 4, the smartphone (2) is equipped with a special stylus.
